(19) United States
(12) Patent Application Publication
(10) Pub. No.: US 2014/0313293 A1
(43) Pub. Date: Oct. 23, 2014

(54) DEPTH MEASURING SCHEMES

(71) Applicant: Speech Innovation Consulting Group Co., Ltd., Seoul (KR)

(72) Inventor: Seung Il KIM, Seoul (KR)

(73) Assignee: Speech Innovation Consulting Group Co., Ltd., Seoul (KR)

(21) Appl. No.: 14/014,748

(22) Filed: Aug. 30, 2013

(30) Foreign Application Priority Data
Apr. 23, 2013 (KR) 10-2013-0045035

(51) Int. Cl. H04N 13/02

(52) U.S. Cl. CPC H04N 13/0207
USPC 348/46

(57) ABSTRACT

A system may include a first apparatus configured to: project a first particle pattern onto a first target region; and a second apparatus configured to: detect the first particle pattern from a second target region that is overlapped with at least a part of the first target region, project a second particle pattern that is different from the first particle pattern onto the second target region, capture an image of the second target region, and process the captured image to reconstruct a three-dimensional (3D) image of the second target region.

### FIELD

Example embodiments broadly relate to a system and a method for reconstructing a three-dimensional image of an object based on a projected light particle pattern.

### BACKGROUND

Friendly interaction between humans and computers is critical for the development of electronic entertainments such as a gesture-based game. The rapid development of motion analysis technologies has introduced possibility of new ways of interacting with computers. Further, depth measuring schemes have become more popular due to technologies used for gesture recognition and human skeletal tracking in consumer electronic systems and in console games.

### SUMMARY

According to an aspect of example embodiments, there is provided a system including a first apparatus configured to: project a first particle pattern onto a first target region; and a second apparatus configured to: detect the first particle pattern from a second target region that is overlapped with at least a part of the first target region, project a second particle pattern that is different from the first particle pattern onto the second target region, capture an image of the second target region, and process the captured image to reconstruct a three-dimensional (3D) image of the second target region.

The first apparatus may select the first particle pattern from among a plurality of particle patterns and the second apparatus may select the second particle pattern from among the plurality of particle patterns.

The first apparatus may further capture an image of the first target region and process the captured image using a first mask that is selected from among a plurality of masks to reconstruct a three-dimensional (3D) image of the first target region.

The first apparatus may process the captured image by: detecting the first particle pattern from the captured image using the first mask; and reconstructing the 3D image of the first target region based at least in part on the detected first particle pattern.

The first apparatus may further detect the second particle pattern using a second mask that is selected from among a plurality of masks, and the second apparatus may detect the first particle pattern using a first mask that is selected from among the plurality of masks.

The first apparatus may comprise: a transparency that is rotatable and has a reference particle pattern; a controller configured to rotate the transparency so as to make the reference particle pattern matched with the first particle pattern; and a light source configured to emit a light to the transparency so as to project the first particle pattern onto the first target region.

The first apparatus may comprise: a plurality of transparencies having a plurality of reference particle patterns; a controller configured to select a transparency having a reference particle pattern that is matched with the first particle pattern from among the plurality of transparencies; and a light source configured to emit a light to the selected transparency so as to project the first particle pattern onto the first target region.

According to another aspect of example embodiments, an apparatus may comprise: an image capture unit configured to capture an image of a first particle pattern that is projected onto a surface of an object; and an image processor configured to process the captured image using a first mask that is selected from among a plurality of masks to reconstruct a three-dimensional (3D) image of the object.

The apparatus may further comprise a particle pattern generator configured to project the first particle pattern that is selected from among a plurality of particle patterns.

The image capture unit may further capture an image of a target region where the first particle pattern is to be projected, prior to the projection of the first particle pattern by the particle pattern generator.

The image processor may further detect a second particle pattern that is projected onto the target region by another apparatus.

The particle pattern generator may further select the first particle pattern that is different from the second particle pattern, upon detecting the second particle pattern.

The image processor may further detect the second particle pattern by using a second mask that is selected from among the plurality of masks.

The captured image may be processed by: detecting the first particle pattern from the captured image using the first mask; and reconstructing the 3D image of the object based at least in part on the detected first particle pattern.

The particle pattern generator may comprise: a transparency that is rotatable and has a reference particle pattern; a controller configured to rotate the transparency so as to make the reference particle pattern matched with the first particle pattern; and a light source configured to emit a light to the transparency so as to project the first particle pattern onto the surface of the object.

The particle pattern generator may comprise: a plurality of transparencies having a plurality of reference particle patterns; a controller configured to select a transparency having a reference particle pattern that is matched with the first particle pattern from among the plurality of transparencies; and a light source configured to emit a light to the selected transparency so as to project the first particle pattern onto the surface of the object.

According to another aspect of example embodiments, a method performed under control of an apparatus comprises: projecting a first particle pattern that is selected from among a plurality of particle patterns onto a surface of an object; capturing an image of the first particle pattern that is projected onto the surface of the object; and processing the captured image using a first mask that is selected from among a plurality of masks to reconstruct a three-dimensional (3D) image of the object.

The processing may comprise: detecting the first particle pattern by using the first mask; and reconstructing the 3D image of the object based at least in part on the detected first particle pattern.

The method may further comprise: prior to projecting of the first particle pattern, capturing an image of a target region where the first particle pattern is to be projected; detecting, from the image of the target region, a second particle pattern that is projected by another apparatus; and selecting the first particle pattern that is different from the second particle pattern.

The detecting of the second particle pattern may be performed by using a second mask that is selected from among the plurality of masks.

The projecting of the first particle pattern may comprise: rotating a transparency that is rotatable and has a reference particle pattern to make the reference particle pattern matched with the first particle pattern; and emitting a light to the transparency.

The projecting of the first particle pattern may comprise: selecting a transparency having a reference particle pattern that is matched with the first particle pattern from among a plurality of transparencies; and emitting a light to the selected transparency.

### BRIEF DESCRIPTION OF THE DRAWINGS

Non-limiting and non-exhaustive example embodiments will be described in conjunction with the accompanying drawings. Understanding that these drawings depict only example embodiments and are, therefore, not intended to limit its scope, the example embodiments will be described with specificity and detail taken in conjunction with the accompanying drawings, in which:

FIG. 1 shows a schematic top view of a system for reconstructing a three-dimensional image of an object, in accordance with example embodiments described herein;

FIG. 2A schematically shows an illustrative example of a partial view of a first light particle pattern, in accordance with example embodiments described herein;

FIG. 2B schematically shows an illustrative example of a partial view of a second light particle pattern, in accordance with example embodiments described herein;

FIG. 3 schematically shows an illustrative example of a first target region and a second target region, in accordance with example embodiments described herein;

FIG. 4A schematically shows an illustrative example of detecting a first light particle pattern from a first target region image by using a first mask, in accordance with example embodiments described herein;

FIG. 4B schematically shows an illustrative example of the first light particle pattern detected from the first target region image, in accordance with example embodiments described herein;

FIG. 5A schematically shows an illustrative example of detecting a second light particle pattern from the first target region image by using a second mask, in accordance with example embodiments described herein;

FIG. 5B schematically shows an illustrative example of the second light particle pattern detected from the first target region image, in accordance with example embodiments described herein;

FIG. 6 shows a schematic block diagram illustrating an architecture for a first apparatus, in accordance with example embodiments described herein;

FIG. 7A shows a schematic diagram illustrating an architecture for a particle pattern generator, in accordance with example embodiments described herein;

FIGS. 7B and 7C schematically show illustrative examples of a transparency, in accordance with example embodiments described herein;

FIG. 8 schematically shows illustrative examples of the transparency rotated to generate a plurality of light particle patterns, in accordance with example embodiments described herein; and

FIG. 9 shows an example processing flow for reconstructing a three-dimensional image of an object.

### DETAILED DESCRIPTION

Hereinafter, some embodiments will be described in detail. It is to be understood that the following description is given only for the purpose of illustration and is not to be taken in a limiting sense. The scope of the invention is not intended to be limited by the embodiments described hereinafter with reference to the accompanying drawings, but is intended to be limited only by the appended claims and equivalents thereof.

It is also to be understood that in the following description of embodiments any direct connection or coupling between functional blocks, devices, components, circuit elements or other physical or functional units shown in the drawings or described herein could also be implemented by an indirect connection or coupling, i.e. a connection or coupling comprising one or more intervening elements. Furthermore, it should be appreciated that functional blocks or units shown in the drawings may be implemented as separate circuits in some embodiments, but may also be fully or partially implemented in a common circuit in other embodiments. In other words, the provision of functional blocks in the drawings is intended to give a clear understanding of the various functions performed, but is not to be construed as indicating that the corresponding functions are necessarily implemented in physically separate entities.

It is further to be understood that any connection which is described as being wire-based in the following specification may also be implemented as a wireless communication connection unless noted to the contrary.

The features of the various embodiments described herein may be combined with each other unless specifically noted otherwise. On the other hand, describing an embodiment with a plurality of features is not to be construed as indicating that all those features are necessary for practicing the present invention, as other embodiments may comprise less features and/or alternative features.

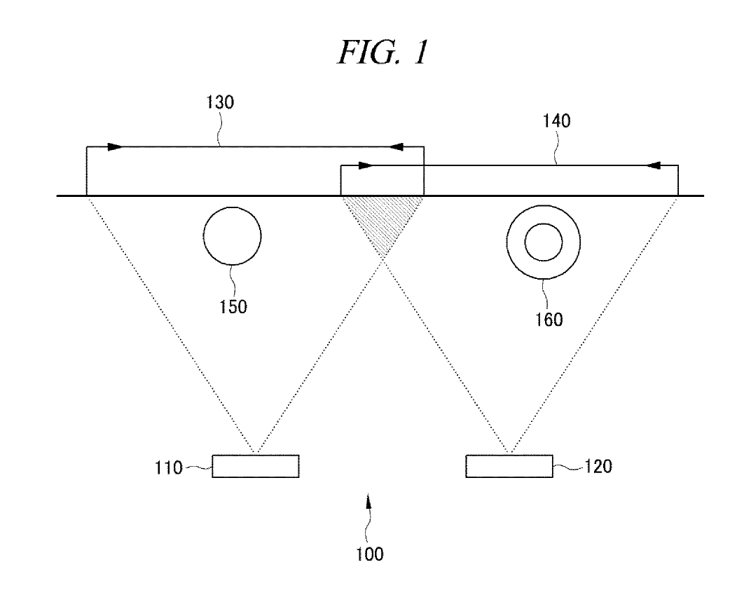

FIG. 1 shows a schematic top view of a system 100 for reconstructing a three-dimensional image of an object, in accordance with example embodiments described herein. As depicted in FIG. 1, system 100 may include at least a first apparatus 110 and a second apparatus 120. Each of first apparatus 110 and second apparatus 120 may be configured to generate and project at least one light particle pattern onto a surface of at least one object. The term “light” may refer to any sort of optical radiation, which includes infrared and ultraviolet, as well as visible light. Further, each of first apparatus 110 and second apparatus 120 may be configured to capture an image of the light particle pattern projected on the surface of the at least one object.

Further, respective first apparatus 110 and second apparatus 120 may be configured to process the captured image of the light particle pattern in order to determine a location of the at least one object and to perform 3D ranging and/or 3D mapping of the at least one object. The term “3D ranging” may refer to measuring or estimating a distance from a given coordinate origin to the location of an object in a 3D coordinate frame. Further, the term “3D mapping” may refer to generating a set of 3D coordinates representing a surface of an object. The derivation of such a 3D map based on the captured image of the light particle pattern may be referred to as “3D reconstruction”. The 3D map reconstructed by system 100 may be used for a wide range of different purposes. By way of example, but not limitation, the 3D map may be sent to an output device, such as a television, a monitor, etc, and be used to provide a gesture-based user interface.

In some embodiments, first apparatus 110 may be configured to project a first light particle pattern onto a first target region 130. A first object 150 (e.g., a ball) may be positioned in front of first target region 130, so the first light particle pattern may also be projected onto a surface of first object 150. Second apparatus 120 may be configured to project a second light particle pattern onto a second target region 140. A second object 160 (e.g., a vase) may be positioned in front of second target region 140, so the second light particle pattern may also be projected onto a surface of second object 160.

In some circumstances, first target region 130 may be overlapped with at least a part of second target region 140, so an overlapped region 170 may exist between a right side of the first light particle pattern and a left side of the second light particle pattern.

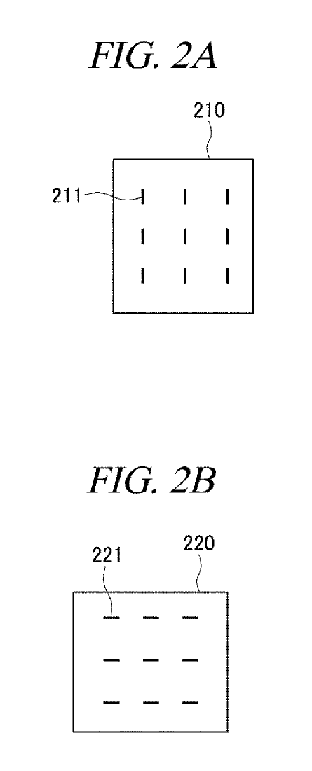

FIG. 2A schematically shows an illustrative example of a partial view of a first light particle pattern, in accordance with example embodiments described herein and FIG. 2B schematically shows an illustrative example of a partial view of a second light particle pattern, in accordance with example embodiments described herein. By way of example, but not limitation, a first light particle pattern 210, which is projected by first apparatus 110, may include multiple first light particles 211. Further, a second light particle pattern 220, which is projected by second apparatus 120, may include multiple second light particles 221. As depicted in FIGS. 2A and 2B, first light particle pattern 210 is different or independent from second light particle pattern 220. The term “different” or “independent” may mean that first apparatus 110 is able to detect only first light particle pattern 210 from an image including both first light particle pattern 210 and second light particle pattern 220 without confusion and second apparatus 120 is able to detect only second light particle pattern 220 from the same image.

As depicted in FIGS. 2A and 2B, each first light particle 211 has a vertical bar shape and each second light particle 221 has a horizontal bar shape. However, it will be apparent to those skilled in the art that shapes of first light particles 211 and second light particle 221 may be changed to any type of shapes that is independently recognizable.

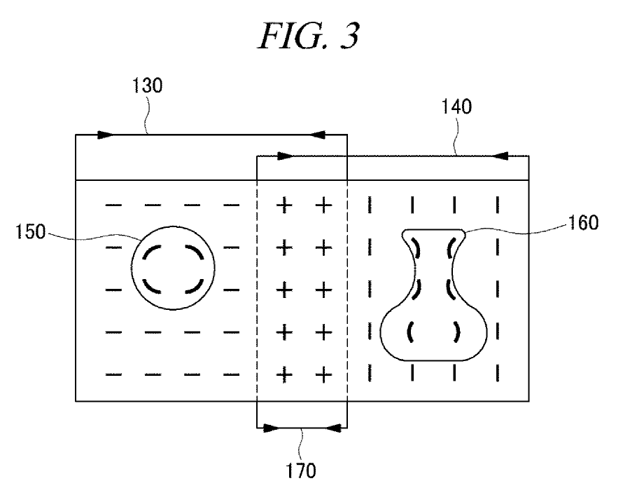

FIG. 3 schematically shows an illustrative example of a first target region 130 and a second target region 140, in accordance with example embodiments described herein. As depicted in FIG. 3, first light particle pattern 210 may be projected onto the surface of first object 150 in front of first target region 130. Further, second light particle pattern 220 may be projected onto the surface of second object 160 in front of second target region 140, which includes overlapped region 170. In this case, overlapped region 170 may exist between first and second target regions 130 and 140.

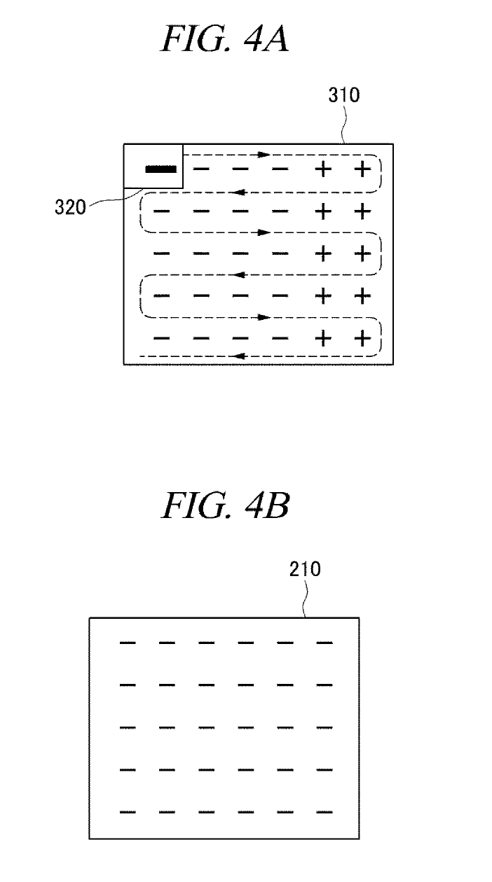

FIG. 4A schematically shows an illustrative example of detecting a first light particle pattern from a first target region image 310 by using a first mask 320, in accordance with example embodiments described herein. FIG. 4B schematically shows an illustrative example of first light particle pattern 210 detected from first target region image 310, in accordance with example embodiments described herein.

In some embodiments, first apparatus 110 may be configured to capture an image 310 of first target region 130 by using a camera or image sensor, which is operatively coupled to first apparatus 110 or another apparatus. First apparatus 110 may be further configured to process the captured first target region image 310 to reconstruct a three-dimensional (3D) image of first object 150. In some embodiments, first apparatus 110 may be configured to select a first mask 320 that corresponds to first light particle 211 from among multiple masks. In some examples, first apparatus 110 may be configured to generate and configure first mask 320 based on a predefined algorithm, which is programmed in software. First apparatus 110 may be further configured to detect first light particle pattern 210 from first target region image 310 by scanning first target region image 310 in a predetermined order with first mask 320.

Further, first apparatus 110 may be configured to reconstruct the 3D image of first object 150 by using any well-known 3D image recovering schemes based at least in part on first light particle pattern 210, which is detected from first target region image 310. By way of example, but not limitation, first apparatus 110 may be configured to compute 3D coordinates of the surface of first object 150 by triangulation, based on the transverse shifts of first light particle 211 that is included in the detected first light particle pattern 210 relative to a reference light pattern at a known distance from first apparatus 110.

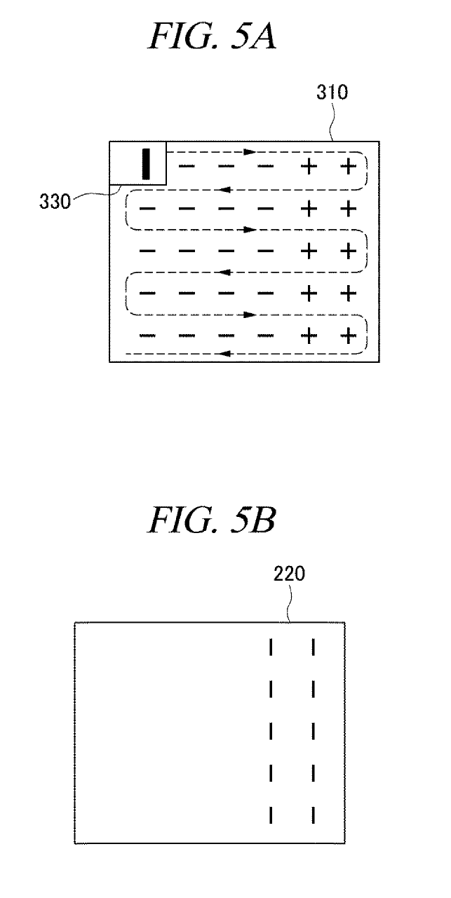

FIG. 5A schematically shows an illustrative example of detecting a second light particle pattern from first target region image 310 by using a second mask 330, in accordance with example embodiments described herein. FIG. 5B schematically shows an illustrative example of second light particle pattern 220 detected from first target region image 310, in accordance with example embodiments described herein.

In some embodiments, prior to projecting first light particle pattern 210 onto first target region 130, first apparatus 110 may be configured to investigate whether a similar or same light particle pattern as first light particle pattern 210 has already been projected onto at least a part of first target region 130 by another apparatus. The term “similar” or “same” may mean that first apparatus 110 is not able to clearly distinguish first light particle pattern 210 from another light particle pattern. As a result of the investigation, if there is no similar or same light particle pattern as first light particle pattern 210 on first target region 130, first apparatus 110 may be configured to select and project first light particle pattern 210 onto first target region 130. In contrast, if there exists the similar or same light particle pattern as first light particle pattern 210 on first target region 130, first apparatus 110 may be configured to select and project another light particle pattern, which is different or independent from first light particle pattern 210.

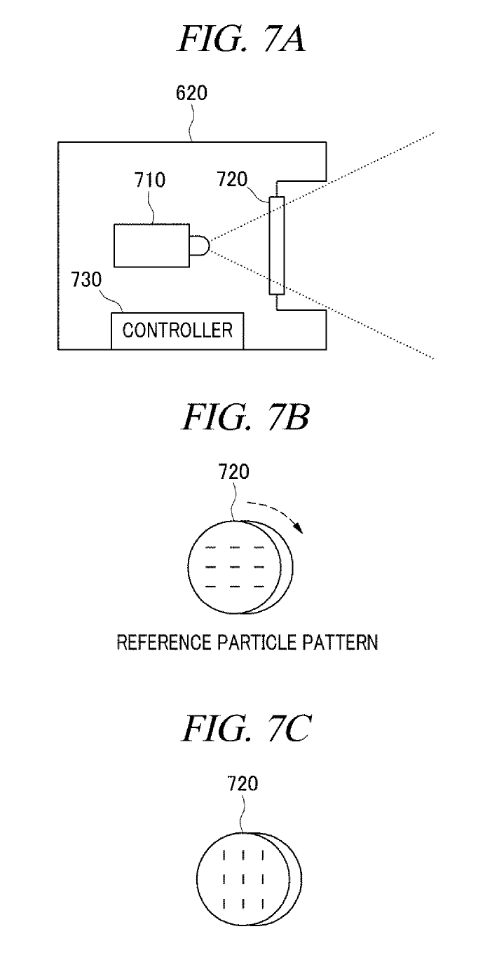

Similarly, first apparatus 110 may be configured to select a second mask 330 that corresponds to second light particle 221 from among the multiple masks. Then, first apparatus 110 may detect second light particle pattern 220 from first target region image 310 by scanning first target region image 310 in a predetermined order with second mask 330. Details of selecting first light particle pattern 210 by first apparatus 110 are described with reference to FIGS. 7A to 7C that follow and are described herein below with reference thereto.

Although FIGS. 4A to 5B are described with reference to first apparatus 110, it will be apparent to those skilled in the art that the same or analogous process or operation as first apparatus 110 may be executed by second apparatus 120. In some embodiments, second apparatus 120 may be configured to capture an image of second target region 140. Further, second apparatus 120 may be configured to investigate whether second light particle pattern 220 has already been projected onto second target region 140.

Further, second apparatus 120 may be configured to process the captured second target region image to reconstruct a three-dimensional (3D) image of second object 160. In some examples, second apparatus 120 may be configured to select second mask 330 that corresponds to second light particle 221 from among the multiple masks. Second apparatus 120 may be further configured to detect second light particle pattern 220 from the captured second target region image by scanning the captured second target region image with second mask 330. Further, second apparatus 120 may be configured to reconstruct the 3D image of second object 160 by using any well-known 3D image recovering schemes based at least in part on second light particle pattern 220, which is detected from the captured second target region image.

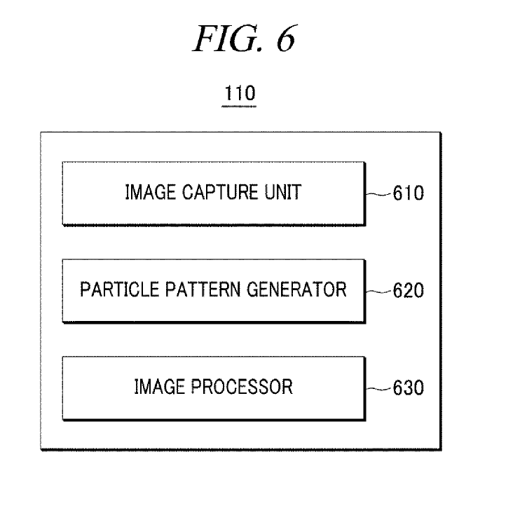

FIG. 6 shows a schematic block diagram illustrating an architecture for first apparatus 110, in accordance with example embodiments described herein. As depicted in FIG. 1, first apparatus 110 may include an image capture unit 610, a particle pattern generator 620 and an image processor 630. It will be understood by those skilled in the art that each function and/or operation of the components may be implemented, individually and/or collectively, by a wide range of hardware, software, firmware, or virtually any combination thereof. In that regard, one or more of image capture unit 610, particle pattern generator 620 and image processor 630 may be implemented in an application executable on first apparatus 110 and the application may be installed on first apparatus 110 upon downloading the application from a predetermined website or an on-line application store.

Image capture unit 610 may be configured to capture an image of a first light particle pattern that is projected onto a surface of an object. By way of example, but not limitation, image capture unit 610 may include objective optics, which focus the captured image of the first light particle pattern onto an image sensor. The image sensor may include an array of detector elements such as a charge coupled device (CCD) or complementary metal-oxide semiconductor (CMOS)-based image sensor array.

Further, prior to the projection of the first light particle pattern, for the preliminary investigation, image capture unit 610 may be configured to capture an image of a target region where the first light particle pattern is will be projected.

Particle pattern generator 620 may be configured to select a light particle pattern that is distinguishable from other light particle patterns. In some embodiments, if a certain light particle pattern that has already been projected onto the target region by another apparatus is detected from the target region image captured by image capture unit 610, particle pattern generator 620 may select a distinguishable light particle pattern that is different from the detected light particle pattern. Alternatively, if there is no light particle pattern on the target region image captured by image capture unit 610, particle pattern generator 620 may select any light particle pattern from among multiple light particle patterns. Further, particle pattern generator 620 may be configured to project the selected light particle pattern onto the target region.

Image processor 630 may be configured to process the target region image captured by image capture unit 610 in order to reconstruct a three-dimensional (3D) image of the object. In some embodiments, image processor 630 may be configured to detect the projected light particle pattern from the captured target region image by using a mask that corresponds to the projected light particle pattern. For example, image processor 630 may select a first mask from among multiple masks if the first light particle pattern has been projected. In some examples, image processor 630 may be configured to generate and configure the first mask based on a predefined algorithm, which is programmed in software. Further, image processor 630 may be configured to reconstruct the 3D image of the object based at least in part on the detected light particle pattern by using any well-known 3D image recovering schemes.

Further, in some embodiments, prior to the projection of a certain light particle pattern by particle pattern generator 620, image processor 630 may preliminarily inspect all kinds of light particle patterns, which have been projected onto the target region by other apparatuses

By way of example, but not limitation, image processor 630, which performs 3D image reconstructions, may be configured to include a general purpose computer processor, which is programmed in software to carry out the functions or operations described above. The software may be downloaded to image processor 630 in electronic form over a network, or it may alternatively be provided on tangible media, such as optical, magnetic, or electronic memory media. Alternatively or additionally, some or all of the functions of image processor 630 may be implemented in dedicated hardware, such as a custom or semi-custom integrated circuit or a programmable digital signal processor (DSP). Although image processor 630 is shown in FIG. 6 as a module included in first apparatus 110, some or all of the functions of image processor 630 may be performed by a separate unit from first apparatus 110, which is operatively coupled to first apparatus 110.

FIG. 7A shows a schematic diagram illustrating an architecture for particle pattern generator 620, in accordance with example embodiments described herein. As depicted in FIG. 7A, particle pattern generator 620 may include a light source 710, a transparency 720 and a controller 730. It will be understood by those skilled in the art that each function and/or operation of the components may be implemented, individually and/or collectively, by a wide range of hardware, software, firmware, or virtually any combination thereof.

Light source 710 may be configured to emit a light with optical radiation to transparency 720 so as to project a certain light particle pattern onto a target region. The term “light” and “optical radiation” may refer to any band of optical radiation, including infrared and ultraviolet, as well as visible light. By way of example, but not limitation, light source 710 may include a point source by which rays of light source 710 emanate from a locus small enough so that a light particle pattern on transparency 720 is replicated sharply on the target region. Light source 710 may include, for example, a coherent source with large angular divergence, such as a laser diode. In other example, light source 710 may include a non-point source, such as a light-emitting diode (LED). In this example, the light may be emitted from light source 710 to transparency 720 with additional suitable sort of projection optics.

Transparency 720 may have a reference particle pattern. By way of example, but not limitation, the reference particle pattern may include multiple lines that are arranged regularly, e.g., at the regular interval. Further, transparency 710 may be configured to be rotatable, so as to generate a plurality of light particle patterns that are distinguishable. Non-limiting examples of transparency 710 may include a transparent slide or foils.

Controller 730 may be configured to rotate transparency 710 so as to make the reference particle pattern matched with one of the plurality of light particle patterns, e.g., the first light particle pattern. The light emitted from light source 710 may be illuminated to the reference particle pattern of transparency 710, which has been rotated to make the first light particle pattern, so the first light particle pattern is projected onto the target region.

FIGS. 7B and 7C schematically show illustrative examples of transparency 720, in accordance with example embodiments described herein. For example, as depicted in FIG. 7B, transparency 720 may have a reference particle pattern that includes multiple horizontal lines. If controller 730 rotates transparency 720 by ninety degrees, the reference particle pattern becomes a first light particle pattern that has a vertical bar shape as depicted in FIG. 7C.

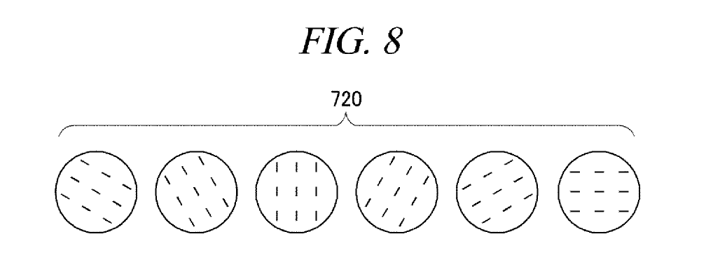

FIG. 8 schematically shows illustrative examples of transparency 720 rotated to generate a plurality of light particle patterns, in accordance with example embodiments described herein. By way of example, when transparency 720 has a reference particle pattern that includes multiple horizontal lines as depicted in FIG. 7B, if particle pattern generator 620 rotates transparency 720 by thirty degrees, six light particle patterns distinguishable from each other may be generated.

In some other example embodiments, particle pattern generator 620 may include multiple transparencies, each of which has a different or independent reference particle pattern. By way of example, but not limitation, a first transparency may have a first reference particle pattern that may include multiple vertical lines and a second transparency may have a second reference particle pattern that may include multiple horizontal lines. Further, controller 730 may be configured to select a transparency having a reference particle pattern matched with one of multiple light particle patterns, e.g., the first light particle pattern, from among the multiple transparencies. Further, light source 710 may be configured to emit a light with optical radiation to the selected transparency so as to project a certain light particle pattern, e.g., the first light particle pattern, onto a target region.

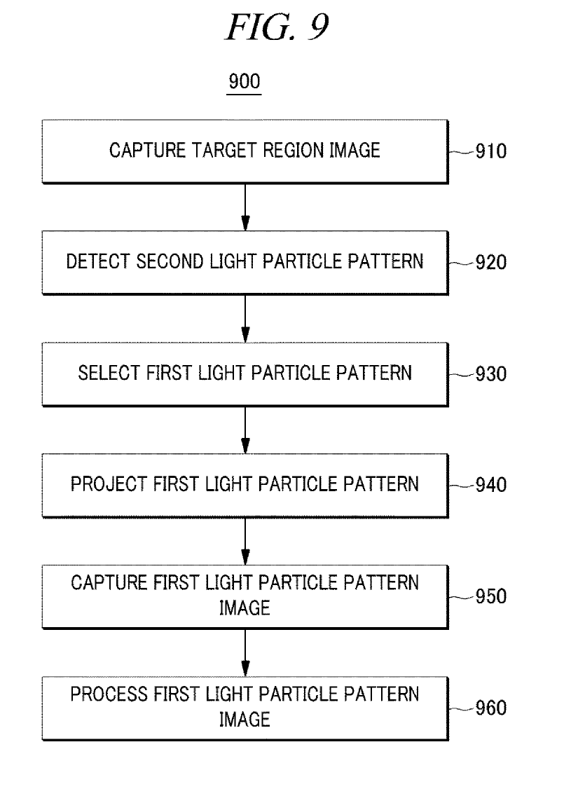

FIG. 9 shows an example processing flow 900 for reconstructing a three-dimensional image of an object. The process in FIG. 9 may be implemented by first apparatus 110 illustrated in FIGS. 6 and 7A. An example process may include one or more operations, actions, or functions as illustrated by one or more blocks 910, 920, 930, 940, 950, and/or 960. Although illustrated as discrete blocks, various blocks may be divided into additional blocks, combined into fewer blocks, or eliminated, depending on the desired implementation. Processing may begin at block 910.

At block 910 (Capture Target Region Image), first apparatus 110 may previously capture an image of a target region where a first light particle pattern will be projected. Processing may proceed from block 910 to block 920.

At block 920 (Detect Second Light Particle Pattern), first apparatus 110 may investigate a light particle pattern that has been projected by another apparatus, and, thus, may detect a second light particle pattern from the target region image captured at block 910. To detect the second light particle pattern, first apparatus 110 may select a second mask that corresponds to the second light particle pattern from among multiple masks. Then, first apparatus 110 may scan the captured target region image with the second mask in order to detect the second light particle pattern. Processing may proceed from block 920 to block 930.

At block 930 (Select First Light Particle Pattern), first apparatus 110 may select the first light particle pattern from multiple light particle patterns. In some embodiments, if the second light particle pattern is detected at block 920, first apparatus 110 may select the first light particle pattern that is different from the second light particle pattern. Alternatively, if no light particle pattern is detected at block 920, first apparatus 110 may select an arbitrary light particle pattern. By way of example, first apparatus 110 may select the first light particle pattern by rotating a transparency, which has a reference particle pattern, to make the reference particle pattern matched the first light particle pattern. By way of another example, first apparatus 110 may select the first light particle pattern by selecting a transparency, which has a reference particle pattern matched with the first particle pattern from among multiple transparencies. Processing may proceed from block 930 to block 940.

At block 940 (Project First Light Particle Pattern), first apparatus 110 may project the first light particle pattern, which is selected at block 930, onto the target region, where an object may be positioned. Processing may proceed from block 940 to block 950.

At block 950 (Capture First Light Particle Pattern Image), first apparatus 110 may capture an image of the first light particle pattern that is projected onto the target region and the surface of the object. Processing may proceed from block 950 to block 960.

At block 960 (Process First Light Particle Pattern Image), first apparatus 110 may process the first light particle pattern image captured at block 950 in order to reconstruct a three-dimensional (3D) image of the object. In some embodiments, first apparatus 110 may select a first mask that corresponds to a first light particle from among the multiple masks and detect the first light particle pattern from the captured first light particle pattern image by using the first mask. Then, first apparatus 110 may reconstruct the 3D image of the object based at least in part on the detected first light particle pattern by using any well-known 3D image recovering schemes.

The examples described above, with regard to FIGS. 1-9, may be implemented in a computing environment having components that include, but are not limited to, one or more processors, system memory, and a system bus that couples various system components. Further, the computing environment may include a variety of computer readable media that are accessible by any of the various components, and includes both volatile and non-volatile media, removable and non-removable media.

Various modules and techniques may be described herein in the general context of computer-executable instructions, such as program modules, executed by one or more computers or other devices. Generally, program modules include routines, programs, objects, components, data structures, etc. for performing particular tasks or implement particular abstract data types. Typically, the functionality of the program modules may be combined or distributed as desired in various embodiments.

An implementation of these modules and techniques may be stored on or transmitted across some form of computer readable media. Computer readable media can be any available media that can be accessed by a computer. By way of example, but not limitation, computer readable media may comprise computer storage media and communications media.

Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

Communication media typically embodies computer readable instructions, data structures, program modules, or other data in a modulated data signal, such as carrier wave or other transport mechanism. Communication media also includes any information delivery media. The term modulated data signal means a signal that has one or more of its characteristics set or changed in such a manner as to encode information in the signal. As a non-limiting example only, communication media includes wired media such as a wired network or direct-wired connection, and wireless media such as acoustic, RF, infrared, and other wireless media. Combinations of any of the above are also included within the scope of computer readable media.

Reference has been made throughout this specification to “one embodiment,” “an embodiment,” or “an example embodiment” meaning that a particular described feature, structure, or characteristic is included in at least one embodiment of the present invention. Thus, usage of such phrases may refer to more than just one embodiment. Furthermore, the described features, structures, or characteristics may be combined in any suitable manner in one or more embodiments.

While example embodiments and applications of the present invention have been illustrated and described, it is to be understood that the invention is not limited to the precise configuration and resources described above. Various modifications, changes, and variations apparent to those skilled in the art may be made in the arrangement, operation, and details of the methods and systems of the present invention disclosed herein without departing from the scope of the claimed invention.

One skilled in the relevant art may recognize, however, that the invention may be practiced without one or more of the specific details, or with other methods, resources, materials, etc. In other instances, well known structures, resources, or operations have not been shown or described in detail merely to avoid obscuring aspects of the invention.

What is claimed is:

1. A system, comprising:
a first apparatus configured to:
project a first particle pattern onto a first target region; and
a second apparatus configured to:
detect the first particle pattern from a second target region that is overlapped with at least a part of the first target region,
project a second particle pattern that is different from the first particle pattern onto the second target region,
capture an image of the second target region, and
process the captured image to reconstruct a three-dimensional (3D) image of the second target region.

2. The system of claim 1, wherein the first apparatus is further configured to select the first particle pattern from among a plurality of particle patterns, and
wherein the second apparatus is further configured to select the second particle pattern from among the plurality of particle patterns.

3. The system of claim 1, wherein the first apparatus is further configured to:
capture an image of the first target region; and
process the captured image using a first mask that is selected from among a plurality of masks to reconstruct a three-dimensional (3D) image of the first target region.

4. The system of claim 3, wherein the first apparatus is configured to process the captured image by:
detecting the first particle pattern from the captured image using the first mask; and
reconstructing the 3D image of the first target region based at least in part on the detected first particle pattern.

5. The system of claim 1, wherein the first apparatus is further configured to detect the second particle pattern using a second mask that is selected from among a plurality of masks, and
wherein the second apparatus is configured to detect the first particle pattern using a first mask that is selected from among the plurality of masks.

6. The system of claim 1, wherein the first apparatus comprises:
a transparency that is rotatable and has a reference particle pattern;
a controller configured to rotate the transparency so as to make the reference particle pattern matched with the first particle pattern; and
a light source configured to emit a light to the transparency so as to project the first particle pattern onto the first target region.

7. The system of claim 1, wherein the first apparatus comprises:
a plurality of transparencies having a plurality of reference particle patterns;
a controller configured to select a transparency having a reference particle pattern that is matched with the first particle pattern from among the plurality of transparencies; and
a light source configured to emit a light to the selected transparency so as to project the first particle pattern onto the first target region.

8. An apparatus, comprising:
an image capture unit configured to capture an image of a first particle pattern that is projected onto a surface of an object; and
an image processor configured to process the captured image using a first mask that is selected from among a plurality of masks to reconstruct a three-dimensional (3D) image of the object.

9. The apparatus of claim 8, further comprising:
a particle pattern generator configured to project the first particle pattern that is selected from among a plurality of particle patterns.

10. The apparatus of claim 9, wherein, prior to the projection of the first particle pattern by the particle pattern generator, the image capture unit is further configured to capture an image of a target region where the first particle pattern is to be projected.

11. The apparatus of claim 10, wherein the image processor is further configured to detect a second particle pattern that is projected onto the target region by another apparatus.

12. The apparatus of claim 11, wherein, upon detecting the second particle pattern, the particle pattern generator is further configured to select the first particle pattern that is different from the second particle pattern.

13. The apparatus of claim 12, wherein the image processor is further configured to detect the second particle pattern by using a second mask that is selected from among the plurality of masks.

14. The apparatus of claim 8, wherein the captured image is processed by:
detecting the first particle pattern from the captured image using the first mask; and
reconstructing the 3D image of the object based at least in part on the detected first particle pattern.

15. The apparatus of claim 9, wherein the particle pattern generator comprises:
a transparency that is rotatable and has a reference particle pattern;
a controller configured to rotate the transparency so as to make the reference particle pattern matched with the first particle pattern; and
a light source configured to emit a light to the transparency so as to project the first particle pattern onto the surface of the object.

16. The apparatus of claim 9, wherein the particle pattern generator comprises:
a plurality of transparencies having a plurality of reference particle patterns;
a controller configured to select a transparency having a reference particle pattern that is matched with the first particle pattern from among the plurality of transparencies; and
a light source configured to emit a light to the selected transparency so as to project the first particle pattern onto the surface of the object.

17. A method performed under control of an apparatus, comprising:
projecting a first particle pattern that is selected from among a plurality of particle patterns onto a surface of an object;
capturing an image of the first particle pattern that is projected onto the surface of the object; and
processing the captured image using a first mask that is selected from among a plurality of masks to reconstruct a three-dimensional (3D) image of the object.

18. The method of claim 17, wherein the processing comprises:
detecting the first particle pattern by using the first mask; and
reconstructing the 3D image of the object based at least in part on the detected first particle pattern.

19. The method of claim 17, further comprising, prior to projecting of the first particle pattern:
capturing an image of a target region where the first particle pattern is to be projected;
detecting, from the image of the target region, a second particle pattern that is projected by another apparatus; and
selecting the first particle pattern that is different from the second particle pattern.

20. The method of claim 19, wherein the detecting of the second particle pattern is performed by using a second mask that is selected from among the plurality of masks.

21. The method of claim 17, wherein the projecting of the first particle pattern comprises:
rotating a transparency that is rotatable and has a reference particle pattern, to make the reference particle pattern matched with the first particle pattern; and
emitting a light to the transparency.

22. The method of claim 17, wherein the projecting of the first particle pattern comprises:
selecting a transparency having a reference particle pattern that is matched with the first particle pattern from among a plurality of transparencies; and
emitting a light to the selected transparency.
